(19) United States
(12) Patent Application Publication
(10) Pub. No.: US 2019/0121610 A1
(43) Pub. Date: Apr. 25, 2019

(54) User Interface For Hands Free Interaction

(71) Applicant: Comcast Cable Communications, LLC, Philadelphia, PA (US)

(72) Inventors: Amanda Olsovsky, Philadelphia, PA (US); Neil Epstein, Bryn Mawr, PA (US); Michael Lacek, Philadelphia, PA (US)

(21) Appl. No.: 15/793,200

(22) Filed: Oct. 25, 2017

(51) Int. Cl. G06F 3/16; G10L 15/22

(52) U.S. Cl. CPC G06F 3/167; H04N 21/42222; G10L 15/22

(57) ABSTRACT

A user interface may be determined based on first information and second information received at a computing device. The first information may be indicative of an audio input received at a user device, such as an indication that a trigger word or phrase has been detected at the user device. The second information may comprise metadata that identifies one or more operational characteristics associated with the user device. The user interface may be output or displayed by a playback device and may comprise one or more characteristics configured based on the one or more operational characteristics associated with the user device.

### BACKGROUND

User devices such as voice-activated devices may be controlled using audio inputs such as vocal instructions or utterances from a user. By removing the need to use buttons and other modes of selection, voice-activated devices may be operated by a user such as a human operator in a hands free manner, allowing the user to issue commands while performing other tasks. However, improvements in hands-free user interfaces such as voice-activated devices are needed.

### SUMMARY

Methods and systems are disclosed for determining a user interface for interacting with one or more user devices. The user interface may be determined based on first information and second information received at a computing device. The first information may be indicative of an audio input received at a user device, such as an indication that a trigger word or phrase has been detected at the user device. The second information may comprise metadata that identifies one or more operational characteristics associated with the user device. Determining the user interface may comprise determining one or more characteristics of the user interface based on the audio input and the one or more operational characteristics of the user device.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 is a block diagram of an example system;

FIG. 2 is an example system comprising multiple voice-activated remotes;

FIG. 3 is a flow chart of an example method;

FIGS. 4A and 4B show example user interfaces;

FIG. 5 is a flow chart of an example method;

FIG. 6 is a flow chart of an example use case;

FIG. 7 is a flow chart of an example method;

FIG. 8 is a flow chart of an example method; and

FIG. 9 is a block diagram of an example computing device.

### DETAILED DESCRIPTION OF ILLUSTRATIVE EMBODIMENTS

Methods and systems are disclosed herein for determining and/or outputting (e.g., displaying) a user interface for interacting with one or more user devices, such as voice-activated devices. The user interface may be determined based on an audio input received at the user device and metadata identifying the user device. One or more characteristics of the user interface may be determined based on the operational characteristics associated with the user device. For example, if the audio input comprises a voice command “show me movies” and the metadata contains an indicator that the user device is controllable using one or more buttons, a user interface may be displayed for navigating a list of movies using the one or more buttons of the user device. Additionally or alternatively, if the audio input comprises the same voice command but the metadata contains an indicator that the user device is controllable using one or more voice commands, a user interface may be displayed for navigating the list of movies using one or more additional voice commands.

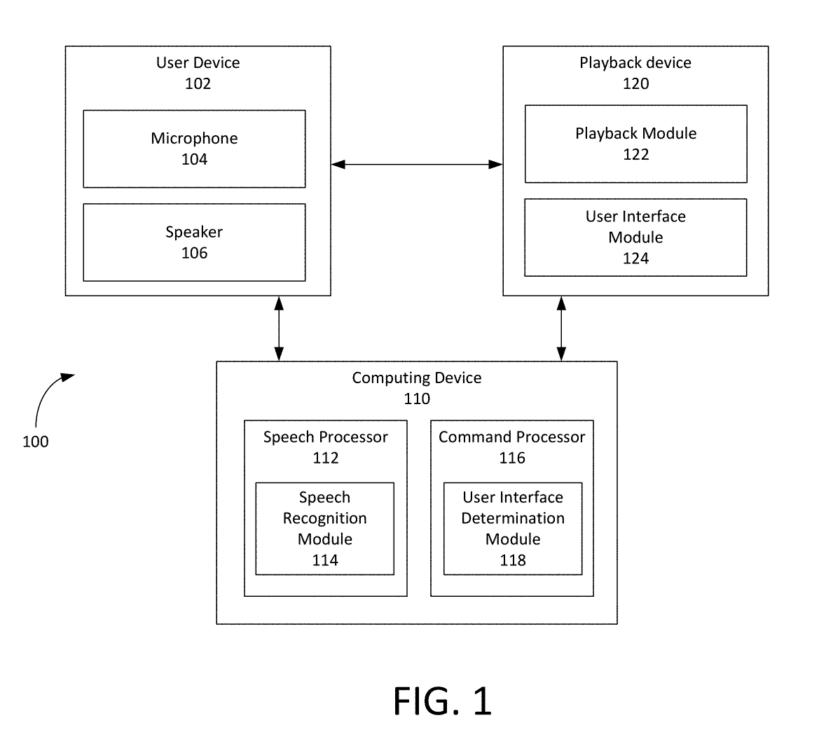

An example system 100 for determining a user interface is illustrated in FIG. 1. The system may comprise a user device 102 such as a voice-activated device. However, it is understood that the user device 102 may be any type of device capable of receiving any type of input. The user device 102 may be configured to receive an audio input comprising a trigger and/or a voice command. The trigger may be a predetermined word, phrase, or passcode that alerts the user device 102 to the presence of a voice command following the trigger, and may serve as an instruction to the user device 102 to cause execution of the voice command or to cause execution of an operation associated with the voice command following the trigger. The trigger may comprise a phrase such as “user device” that serves to instruct the user device 102 to execute a voice command following the trigger.

The user device 102 may comprise a microphone 104 and a speaker 106. At least one of a trigger and a voice command may be received by the user device 102 through the microphone 104 causing the user device 102 to perform some operation associated with the voice command. The user device 102 may be configured to verify the trigger using, for example, speech recognition processing to determine that the trigger corresponds to one or more recognized words or sounds.

In the example that the user device 102 is a voice-activated remote control, also referred to herein as a voice remote, the voice command received through the microphone 104 may be an instruction for the voice remote to communicate with a set top box to display a list of movies. In the example phrase “voice remote, show me popular horror movies” uttered by a user of the voice remote, the trigger may comprise the phrase “voice remote” and the voice command may comprise the command “show me popular horror movies.” Upon verification of the trigger, the voice remote may instruct a nearby set-top box to display, through a user interface, a list of popular horror movies. The voice remote may be configured to interact with the user of the device through the speaker 106, for example, by outputting an audio signal comprising phrases such as “command not recognized” or “please narrow your search.”

A computing device 110 may be configured to receive, from the user device 102, a voice command in response to detection of a trigger at the user device 102. For example, in response to detection of the trigger “voice remote” and the voice command “show me horror movies,” the user device 102 may send, to the computing device 110, the voice command such that the voice command may be processed by the computing device 110. The voice command may be processed by at least one of the speech processor 112 and the command processor 116 associated with the computing device 110.

The speech processor 112 may comprise a speech recognition module 114. The speech recognition module 114 may recognize one or more words spoken by a user of the device 102 and may generate a transcription for sending to one of the user device 102 or the playback device 120 for responding to a voice command. The transcription may be used by the playback device 120, for example, in determining one or more characteristics of a user interface to display. For example, if the received transcription corresponds to a voice command “show me popular movies,” the playback device 120 may output a user interface configured to be operated using a hand held remote control for navigating through a list of popular movies. However, if the received transcription corresponds to a voice command “show me movies that I watched recently,” the playback device 120 may display a user interface with a limited number of movies that the user may select between using additional voice commands.

The speech recognition module 114 may comprise, for example, one or more of a speech capture module, a digital signal processor (DSP) module, a preprocessed signal storage module, and a reference speech pattern and pattern matching algorithm module. Speech recognition may be done in a variety of ways and at different levels of complexity, for example, using one or more of pattern matching, pattern and feature analysis, and language modeling and statistical analysis. However, it is understood that any type of speech recognition may be used, and the examples provided herein are not intended to limit the capabilities of the speech recognition module 114.

Pattern matching may comprise recognizing each word in its entirety and employing a pattern matching algorithm to match a limited number of words with stored reference speech patterns. An example implementation of pattern patching is a computerized switchboard. For example, a person who calls a bank may encounter an automated message instructing the user to say “one” for account balance, “two” for credit card information, or “three” to speak to a customer representative. In this example, the stored reference speech patterns may comprise multiple reference speech patterns for the words “one” “two” and “three.” Thus, the computer analyzing the speech may not have to do any sentence parsing or any understanding of syntax. Instead, the entire chunk of sound may be compared to similar stored patterns in the memory.

Pattern and feature analysis may comprise breaking each word into bits and recognizing the bits from key features, for example, the vowels contained in the word. For example, pattern and feature analysis may comprise digitizing the sound using an analog to digital converter (A/D converter). The digital data may then be converted into a spectrogram, which is a graph showing how the component frequencies of the sound change in intensity over time. This may be done, for example, using a Fast Fourier Transform (FFT). The spectrogram may be broken into a plurality overlapping acoustic frames. These frames may be digitally processed in various ways and analyzed to find the components of speech they contain. The components may then be compared to a phonetic dictionary, such as one found in stored patterns in the memory.

Language modeling and statistical analysis is a more sophisticated speech recognition method in which knowledge of grammar and the probability of certain words or sounds following one from another is used to speed up recognition and improve accuracy. For example, complex voice recognition systems may comprise a vocabulary of over 50,000 words. Language models may be used to give context to words, for example, by analyzing the words proceeding and following the word in order to interpret different meanings the word may have. Language modeling and statistical analysis may be used to train a speech recognition system in order to improve recognition of words based on different pronunciations. While the computing device 110 may comprise any type of speech recognition module 114, it is understood that at least part of the speech recognition process necessary to execute the voice command may be performed by a remote server.

The command processor 116 may be configured to receive, as input from the speech processor 112, a transcription of the audio file. The transcription may be, for example, a speech-to-text translation of the audio file. The command processor 116 may be configured to process the transcription of the audio file and to send, to a playback device, one or more commands based on the processing of the transcription. For example, if the transcription contains text corresponding to a voice command “show me horror movies,” the command processor 116 may instruct the playback device 120 to display a list of horror movies for navigation and selection by a user of the user device 102 and/or the playback device 120.

The command processor 116 may comprise a user interface determination module 118. The user interface determination module 118 may be configured to determine a user interface for interacting with at least one of the user device 102 and the playback device 120. The user interface determination module 118 may be configured to receive first information indicative of an audio input received at the user device 102, such as an indication that a trigger has been received at the user device 102 and/or the voice command received after the detected trigger. The user device may be configured to receive second information comprising metadata that identifies one or more operational characteristics associated with the user device. The metadata may comprise a device identifier, such as a personal identification number (PIN) associated with a given device. Additionally or alternatively, the metadata may comprise an indication of how the first information and the second information were transmitted by the user device. For example, the metadata may comprise an indicator indicating that the voice command was sent to the computing device 110 by the user device 102 through a Wi-Fi connection or via a RF signal. The user interface determination module 118 may be configured to determine, based on at least one of the first information and the second information, a user interface for interacting with the user device 102, and to cause output or display of the user interface by the playback device 120.

The playback device 120 may comprise a playback module 122 and a user interface module 124. The playback module 122 may be configured to play back a content asset in response to a request from a user of the user device 102 or the playback device 120. The playback module 122 may receive, from one of the user device 102 or the computing device 110, an audio signal corresponding to a voice command from a user of the user device 102 to “tune to HBO.” In response to receipt of this indication, the playback module 122 may tune to the channel corresponding to HBO and may begin playback of a content currently being presented by HBO.

The user interface module 124 may be configured to output or display a user interface. The user interface may be capable of being interacted with using, for example, the user device 102, or any other device capable of sending one or more signals to the playback device 120. The user interface module 124 may be configured to receive, from the computing device 110, an instruction to display a particular type of interface based on at least one of the received voice command or an operational characteristic of the user device 102 that received the voice command. In one example, the user interface module 124 of the playback device 120 may be configured to determine a type of interface to display based on at least one of the voice command or an operational characteristic associated with the user device 102 that received the voice command.

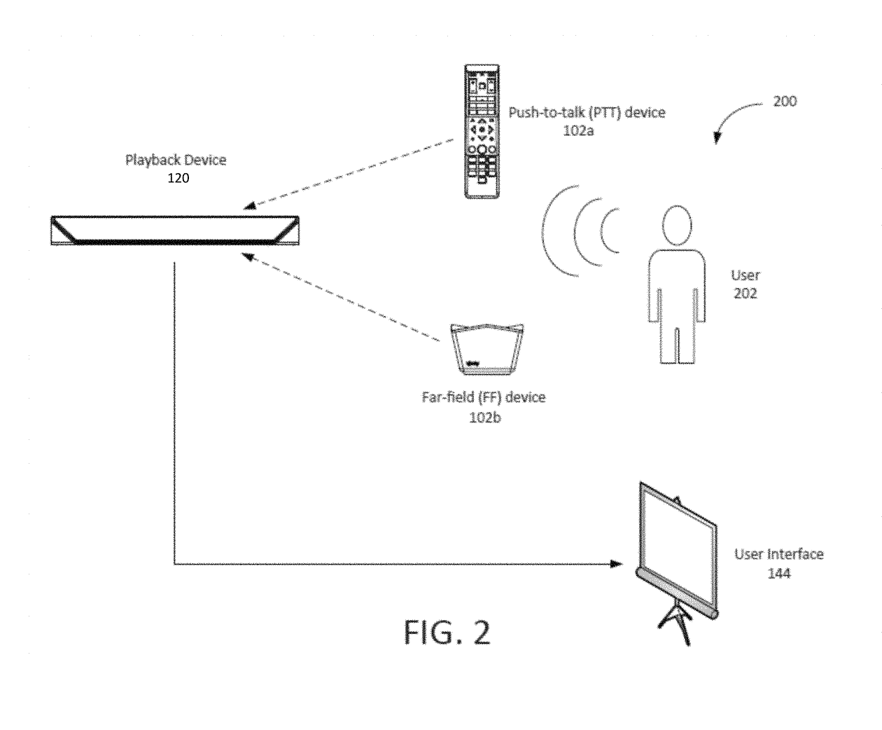

FIG. 2 illustrates an example system 200 comprising a playback device 120, a television or other monitor for presenting a user interface 144, and a plurality of user devices 102a and 102b. The playback device 120 may be, for example, a set top box configured to display a user interface to the user in response to a voice command received at one or more of the user devices 102a and 102b. While FIG. 2 shows two user devices 102a and 102b in communication with a single playback device 120 connected to a single television, it is understood that any number of user devices, playback devices and monitors for presenting interfaces to a user may be used.

The voice remote 102a may be a voice-activated remote control configured to interact with the playback device 120 through at least one of voice activation and one or more buttons located on the voice remote 102a. In one example, the voice remote 102a may be a push-to-talk (PTT) device. The one or more buttons located on the voice remote 102a may be configured to assist a user in navigating a user interface presented by the playback device 120, for example, on a nearby television set. Additionally or alternatively, the voice remote 102a may have limited voice processing capabilities, and the one or more buttons may be used to execute specific commands that are not capable of being executed by voice commands. For example, a user of the voice remote 102a may utter the voice command “show me movies.” The voice remote 102a, upon detecting the voice command and an associated trigger, may send a signal to the playback device 120 causing the playback device 120 to display, through the user interface on the television, a list of movies. The user interface may prompt the user to navigate through the list of movies using the one or more buttons on the voice remote 102a. For example, the user interface may present a keyboard capable of interaction with the voice remote 102a so that the user may enter the title of a particular movie they wish to view.

The user device 102b may be configured to interact with the playback device 120 using one or more voice commands. The user device 102b may not have any buttons located on the device, or may have limited buttons that are not capable of being used to interact with another device such as the playback device 120. In one example, the user device 102b may be a far-field (FF) device. A user of the user device 102b may utter the voice command “show me movies.” The user device 102b, upon detecting the voice command and an associated trigger, may send a signal to the playback device 120 causing the playback device 120 to display, through the user interface on the television, a list of movies. The user may then be promoted, through the user interface, to narrow their search using additional voice commands. For example, the user interface may display a microphone to indicate that it is waiting for additional commands, or may talk back to the user to indicate that the user needs to narrow their search. The user may interact with the playback device 120 through the user device 102b, for example, by uttering additional voice commands such as “show me horror movies released in 2016” or “play ‘The Shining.’”

The playback device 120 may be configured to display a plurality of different user interfaces based on at least one of the received voice command and an operational characteristic associated with the that received the voice command. Each interface may have one or more characteristics based on the operational characteristics of the user device. If a user interface is displayed that is not customized or optimized towards the specific user device, it may not be possible to interact with or navigate the user interface using that device. For example, a user interface configured to be navigated through the use of one or more buttons may not desired if the user is interacting with a user device that lacks buttons and is configured to be controlled solely by the human voice. Similarly, a user interface configured to be navigated solely through the human voice may not be ideal for a user interacting with a user device comprising one or more buttons and limited speech recognition functionality. Thus, it may be desirable for the playback device to receive information about the user device that received the voice command such that the user interface displayed by the playback device is capable of being navigated in an efficient manner using that particular user device.

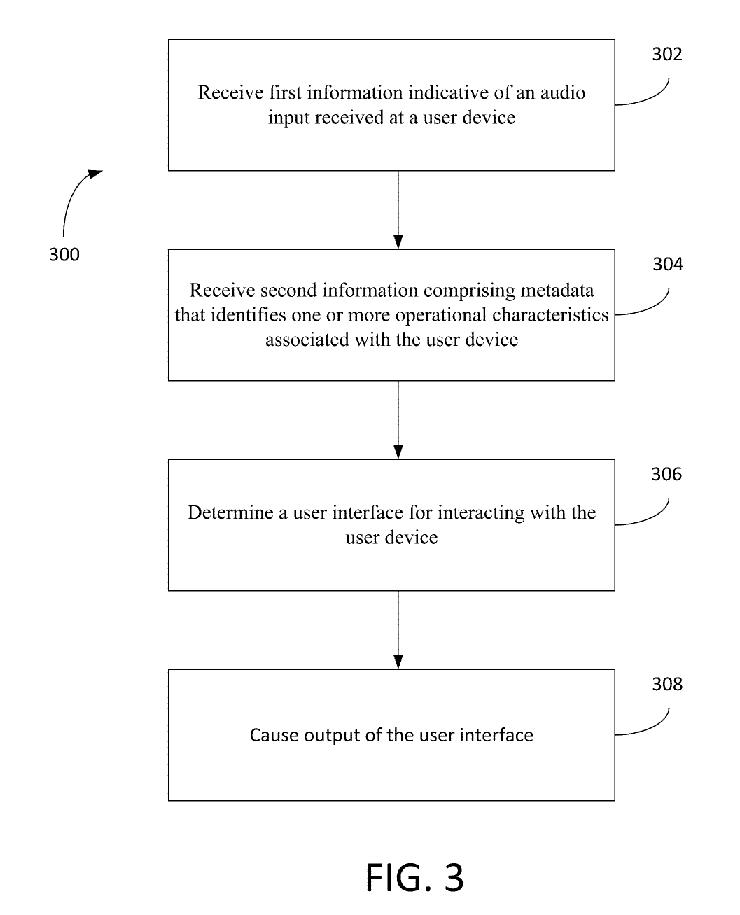

FIG. 3 illustrates an example method 300 in accordance with an aspect of the disclosure. At step 302, first information indicative of an audio input may be received. The first information may be received at a computing device, such as the computing device 110. The first information may comprise at least one of a trigger and a voice command received at a user device 102 (FIG. 1) such as a voice-activated device. The user device may be, for example, a voice-activated remote control. The audio input may be a voice command for accessing a list of content offered by a service provider. For example, the audio input may comprise the trigger “user device” and the voice command “show me popular horror movies.” The computing device, upon verifying the trigger and processing the voice command, may be configured to send a signal to the playback device causing the playback device to display, via a user interface, a list of popular horror movies.

At step 304, second information comprising metadata that identifies one or more operational characteristics associated with the user device may be received. The computing device may be configured to receive, from the user device, metadata comprising information about the user device. The metadata may comprise a device identifier, such as a PIN number, that identifies the user device to the computing device. The computing device, upon receiving a first identifier from the user device, may determine that the user device is a hands free device configured to be operated by the human voice. In response to receiving a second identifier, the computing device may determine that the user device is a device configured to be operated using a combination of the human voice and one or more buttons on the user device. However, it is understood that there may be any number of identifiers associated with any type of device. For example, a third identifier may identify an ordinary remote control that is not configured to receive an audio input. Additionally or alternatively, the metadata may comprise an indication of how the first information and the second information were transmitted by the user device. For example, a user device configured to be controlled by the human voice may send, to at least one of the computing device or the playback device, the audio file via a Wi-Fi connection. In contrast, a voice remote configured to be controlled through a combination of the human voice and one or more buttons located on the voice remote may send, to the computing device or the playback device, the audio signal via a Radio Frequency (RF) signal.

At step 306, a user interface may be determined based on at least one of the first information and the second information. One or more characteristics of the user interface may be configured based on the one or more operational characteristics associated with the user device. The computing device may be configured to store, for a plurality of user devices, one or more operational characteristics associated with each device. For example, upon receiving a voice command and a first identifier, the computing device may cause display of a first user interface configured for navigation using one or more voice commands. Upon receiving a voice command and a second identifier, the computing device may cause display of a second user interface configured for navigation using a combination of voice commands and one or more buttons. Determining a user interface for interacting with the device may comprise selecting the user interface from a plurality of user interfaces associated with one or more recognized user devices. The computing device may be configured to store one or more user interface formats for interacting with the user device. For example, the computing device may store a first type of user interface for navigating using voice commands and second type of user interface for navigating using one or more buttons. The stored user interfaces may have any number of characteristics, such as language, text size, and design schemes.

At step 308, output or display of the user interface may be caused. The computing device may send, to the playback device, an instruction to display the user interface determined based on the first information and the second information. The playback device may be, for example, a set top box in communication with a television or other monitor capable of displaying a user interface. A user may interact with the user interface through the user device based on the one or more operational characteristics associated with the user device. For example, in response to determining, based on the second information, that the user device is a hands-free device, causing display of the user interface may comprise causing display of a user interface capable of receiving input from the user device using the one or more voice commands.

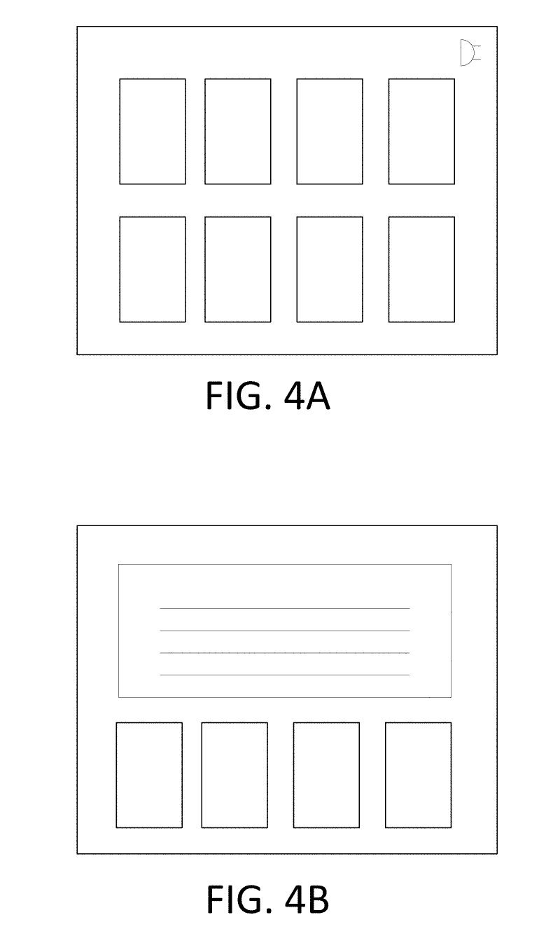

An example user interface configured for interaction using one or more voice commands is illustrated in FIG. 4A. The user interface may display a number of visual representations representing one or more operational characteristics of the user interface. For example, the user interface may be configured to display a microphone to indicate that the user interface is waiting for a command, a timer to indicate that a command is being processed, and a symbol representing that the user interface has timed out and is no longer listening for commands. On the other hand, in response to determining, based on the second information, that the user device is configured to receive commands using one or more buttons located on the user device, causing display of the user interface may comprise causing display of a user interface capable of receiving input from the user device using the one or more buttons or using a combination of voice commands and the one or more buttons. An example user interface configured for interaction using one or more buttons of a voice remote is illustrated in FIG. 4B. The user interface shown in FIG. 4B may comprise a keyboard for interaction with the one or more buttons of the voice remote, for example, to enter the title of a movie.

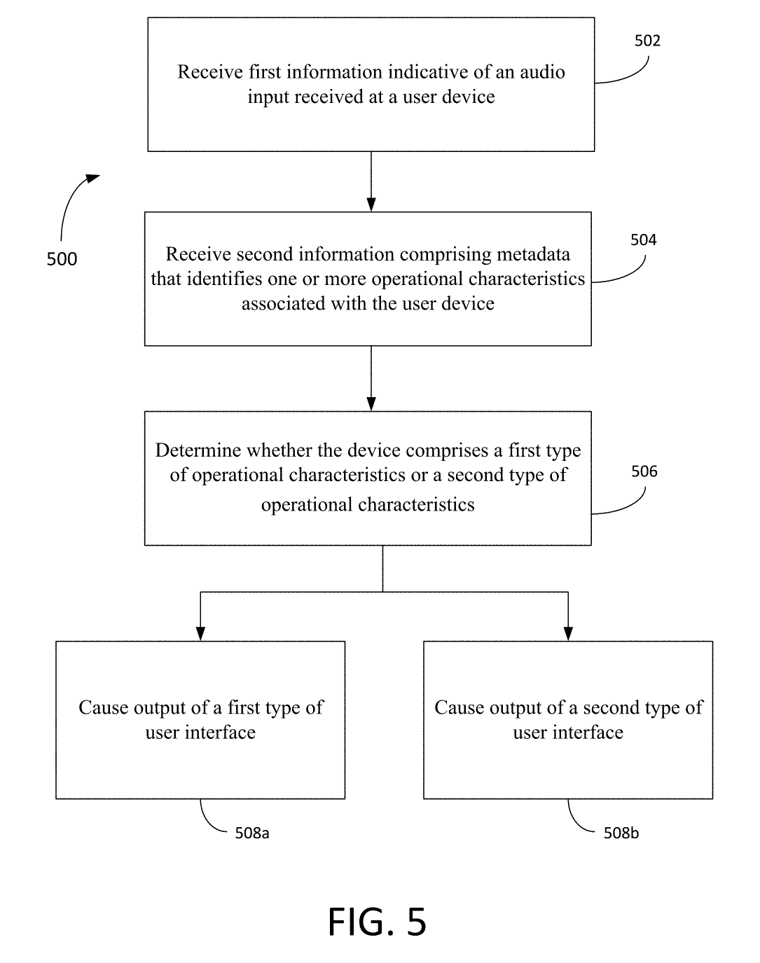

FIG. 5 illustrates an example method 500 in accordance with an aspect of the disclosure. At step 502, first information indicative of an audio input may be received. The first information may be received at a computing device, such as the computing device 110. The first information may comprise at least one of a trigger and a voice command received at a user device 102 (FIG. 1) such as a voice-activated device. The user device may be, for example, a voice-activated remote control. The audio input may be a voice command for accessing a list of content offered by a service provider. For example, the audio input may comprise the trigger “user device” and the voice command “show me popular horror movies.” The computing device, upon verifying the trigger and processing of the voice command, may be configured to send a signal to the playback device causing the playback device to display, via a user interface, a list of popular horror movies.

FIG. 5 illustrates an example method 500 in accordance with an aspect of the disclosure. At step 502, first information indicative of an audio input may be received. The first information may be received at a computing device, such as the computing device 110. The first information may comprise at least one of a trigger and a voice command received at a user device such as the user device 102. The user device may be, for example, a voice-activated remote control. The audio input may be a voice command for accessing a list of content offered by a service provider. For example, the audio input may comprise the trigger “user device” and the voice command “show me popular horror movies.” The computing device, upon verifying the trigger and processing the voice command, may be configured to send a signal to the playback device causing the playback device to display, via a user interface, a list of popular horror movies.

At step 504, second information comprising metadata that identifies one or more operational characteristics associated with the user device may be received. The computing device may be configured to receive, from the user device, metadata comprising information about the user device. The metadata may comprise a device identifier, such as a PIN number, that identifies the user device to the computing device. The computing device, upon receiving a first identifier from the user device, may determine that the user device is a hands free device configured to be operated by the human voice. In response to receiving a second identifier, the computing device may determine that the user device is a device configured to be operated using a combination of the human voice and one or more buttons on the user device. However, it is understood that there may be any number of identifiers associated with any type of device. For example, a third identifier may identify an ordinary remote control that is not configured to receive an audio input.

In one example, the metadata may comprise an indication of how the first information and the second information were transmitted by the user device. For example, a hands free device configured to be controlled by the human voice may send, to at least one of the computing device or the playback device, the audio file via a Wi-Fi connection. In contrast, a voice remote configured to be controlled through a combination of the human voice and one or more buttons located on the voice remote may send, to the computing device or the playback device, the audio signal via a Radio Frequency (RF) signal.

At step 506, it may be determined, based on the second information, whether the device comprises a first type of operational characteristics or a second type of operational characteristics. For example, the second information may comprise metadata, the metadata including one of a device identifier or information about how the audio signal was sent from the user device to the computing device. Based on this metadata, the computing device may determine whether the device identified by the metadata comprises a first type of operational characteristics or a second type of operational characteristics. For example, a device associated with a first identifier may be a hands free device that does not have any buttons for interacting with a user interface, while a device associated with a second identifier may be a voice remote that contains one or more buttons for interacting with a user interface. The computing device may be configured to store a plurality of device identifiers and associated characteristics of devices corresponding to the device identifiers.

At step 508a, in response to determining that the device comprises a first type of operational characteristics, output or display of a first type of user interface may be caused. One or more characteristics of the user interface may be configured based on the one or more operational characteristics associated with the user device. In response to determining, based on the second information, that the user device is a hands-free device, causing display of the user interface may comprise causing display of a user interface capable of receiving input from the user device using the one or more voice commands. The user interface may display a number of visual representations representing one or more operational characteristics of the user interface. For example, the user interface may be configured to display a microphone to indicate that the user interface is waiting for a command, a timer to indicate that a command is being processed, and a symbol representing that the user interface has timed out and is no longer listening for commands.

At step 508b, in response to determining that the device comprises a second type of operational characteristics, output or display of a second type of user interface may be caused. One or more characteristics of the user interface may be configured based on the one or more operational characteristics associated with the user device. In response to determining, based on the second information, that the user device is configured to receive commands using one or more buttons located on the user device, causing display of the user interface may comprise causing display of a user interface capable of receiving input from the user device using the one or more buttons or using a combination of voice commands and the one or more buttons. For example, the second type of user interface may comprise a keyboard for interaction with the one or more buttons of the voice remote, for example, to enter the title of a movie.

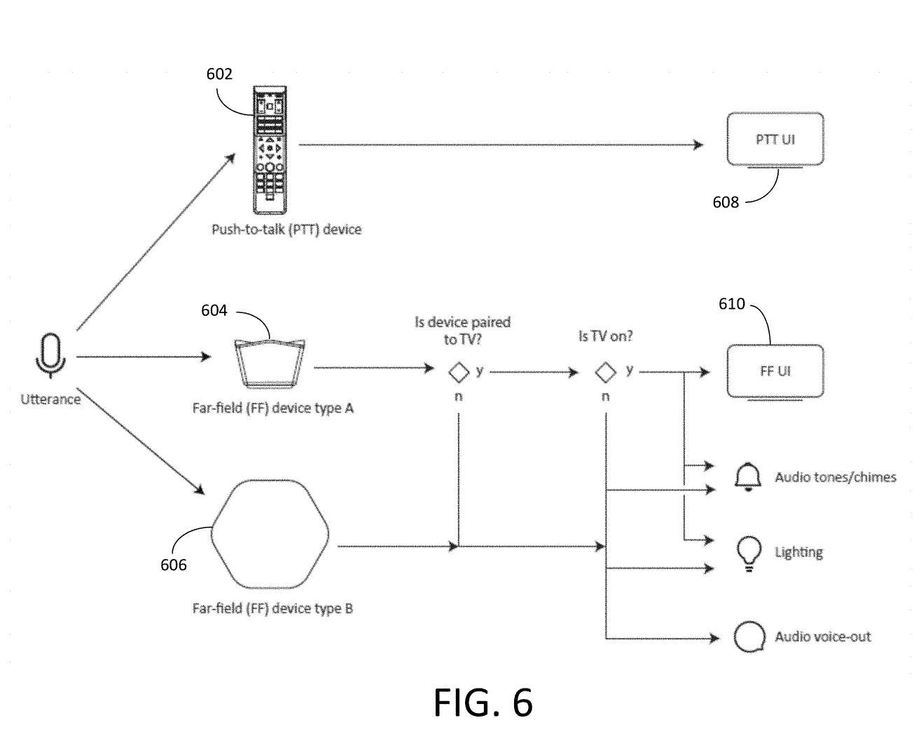

FIG. 6 shows an example use case of a location such as a family household comprising three user devices. User device 602 may be a a push-to-talk (PTT) device such as a voice-activated remote control. A user of the PTT device 602 may be able to interact with one or more other devices connected to the PTT device 602, such as a playback device, through at least one of a voice command and one or more buttons located on the PTT device 602. The one or more buttons located on the PTT device 602 may enable the user of the device to navigate a user interface presented by the playback device, for example, on a nearby television set. The PTT device 602 may be configured to communicate with the playback device or one or more other devices using a Wi-Fi connection.

User device 604 may be a first type (i.e., type A) of far field (FF) device. A user of the type A FF device 604 may be configured to interact with one or more other devices connected to the type A FF device 604, such as a playback device, using one or more voice commands. The type A FF device 604 may not have any buttons located on the device, or may have limited buttons that are not capable of being used to interact with the playback device. For example, the type A FF device 604 may have limited buttons such as those for turning on/off the device and for adjusting a volume of audio playback by the device. However, the limited number of buttons located on the type A FF device 604 may not facilitate interactions with a user interface presented by the playback device. The type A FF device 604 may be configured to communicate with the playback device using a Radio Frequency (RF) signal.

User device 606 may be a second type (i.e., type B) of far field (FF) device. The type B FF device 606 may be configured to receive and to output audio signals as well as to generate other signals such as lighting signals in order to communicate with a user of the device. The type B FF device 606 may not have any buttons located on the device, or may have limited buttons that are not capable of being used to interact with one or more other devices. For example, the type B FF device 606 may have limited buttons such as those for turning on/off the device and for adjusting a volume of audio playback by the device. In contrast to the type A FF device 604, the type B FF device 606 may not be connected with one or more other devices (e.g., a playback device) and thus may not be configured to output a Radio Frequency (RF) signal.

As shown in FIG. 6, an audio signal may be received by at least one of the PTT device 602, the type A FF device 604 or the type B FF device 606. An audio signal received at the PTT device 602 may comprise a voice command uttered by a user of the device, such as “show me movies.” The PTT device 602, in response to receiving the audio signal, may be configured to send the audio signal to one or more other devices, such as a playback device. In addition, the PTT device 602 may be configured to send, to the one or more other devices, metadata that identifies one or more operational characteristics of the PTT device 602. The metadata may comprise, for example, a device identifier such as a PIN number. The one or more other devices may recognize the PIN number and determine that the PTT device 602 comprises one or more buttons for interacting with a user interface. Additionally or alternatively, the metadata may comprise an indication of how the audio signal was transmitted by the PTT device 602. For example, the metadata may indicate that the audio signal was transmitted to the one or more other devices over a Wi-Fi connection. In response to receiving the audio signal and the corresponding metadata, the playback device may be configured to output a PTT interface having one or more characteristics that facilitate interaction between the PTT device 602 and the user interface, such as a user interface capable of being navigated using one or more buttons.

An audio signal received at the type A FF device 604 may comprise a voice command uttered by a user of the device, such as “show me movies.” The type A FF device 604, in response to receiving the audio signal, may be configured to determine whether the type A FF device 604 is paired to a television. Additionally or alternatively, the type A FF device 604 may be configured to determine whether the television is turned on.

In response to determining that the device is connected to a television and that the television is turned on, the type A FF device 604 may be configured to send the audio signal to one or more other devices, such as a playback device connected to the television. In addition, the type A FF device 604 may be configured to send, to the one or more other devices, metadata that identifies one or more operational characteristics of the type A FF device 604. The metadata may comprise, for example, a device identifier such as a PIN number. The one or more other devices may recognize the PIN number and determine that the type A FF device 604 does not comprise one or more buttons for interacting with a user interface. Additionally or alternatively, the metadata may comprise an indication of how the audio signal was transmitted by the type A FF device 604. For example, the metadata may indicate that the audio signal was transmitted to the one or more other devices through a RF signal. In response to receiving the audio signal and the corresponding metadata, the playback device may be configured to output a FF interface having one or more characteristics that facilitate interaction between the type A FF device 604 and the user interface, such as a user interface capable of being navigated using one or more voice commands.

In response to determining either that the device is not connected to a television or that the television is not turned on, the type A FF device 604 may be configured to communicate with a user of the device using at least one of audio tones, lighting signals and audio voice-out signals. In the example that the received audio input comprises the voice command “show me movies,” the type A FF device 604 may output an audio signal comprising the response “not connected to a television.” Additionally or alternatively, the type A FF device 604 may generate one or more audio tones or lighting signals that indicate that the device is not connected to a television. In another example where the audio signal comprises the voice command “what is the temperature outside?” the type A FF device 604 may be configured to output an audio signal comprising the response “the current temperature is 72 degrees.”

An audio signal received at the type B FF device 606 may comprise a voice command uttered by a user of the device, such as “what is the temperature outside.” In contrast to the type A FF device 604, the type B FF device 606 may not be configured to be paired to a television or to communicate with any other devices. Thus, the type B FF device 606 may be configured to communicate with a user of the device using at least one of audio tones, lighting signals and audio voice-out signals. In the example where the audio signal comprises the voice command “what is the temperature outside?” the type B FF device 606 may be configured to output an audio signal comprising the response “the current temperature is 72 degrees.” In another example where the received audio input comprises the voice command “show me movies,” the type B FF device 606 may output an audio signal comprising the response “not connected to a television.” Additionally or alternatively, the type B FF device 606 may generate one or more audio tones or lighting signals that indicate that the device is not connected to a television.

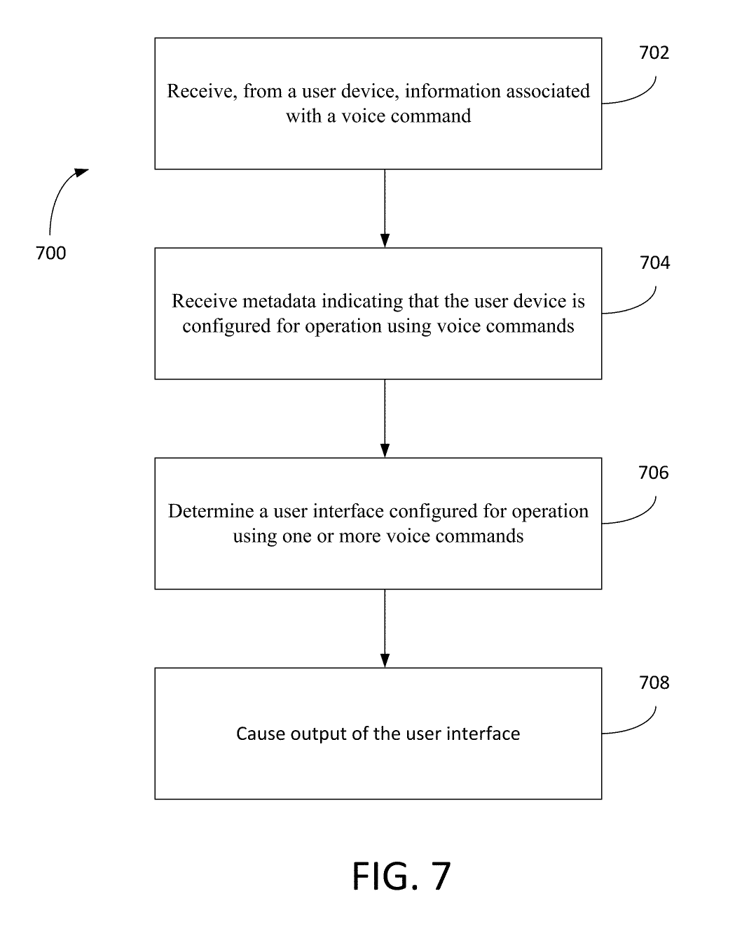

FIG. 7 illustrates an example method 700 in accordance with an aspect of the disclosure. At step 702, information associated with a voice command may be received from a first device, such as user device 102. The information may be received at a computing device, such as the computing device 110. The voice command may be a request for accessing a list of content offered by a service provider. For example, the voice command may comprise the command “show me popular horror movies.”

At step 704, metadata indicating that the user device is configured for operation using one or more voice commands may be received. The metadata may comprise a device identifier, such as a PIN number, that identifies the user device to the computing device. The computing device, upon receiving a first identifier from the user device, may determine that the user device is a hands free device configured to be operated by the human voice. Additionally or alternatively, the metadata may comprise an indication of how the voice command and the metadata were transmitted by the user device. For example, a user device configured to be controlled by the human voice may send, to at least one of the computing device or the playback device, the audio file via a Wi-Fi connection.

At step 706, a user interface may be determined based on the voice command and the received metadata. One or more characteristics of the user interface may be configured based on the one or more operational characteristics associated with the user device. For example, upon receiving the voice command and the metadata indicating that the user device is configured for operation using one or more voice commands, the computing device may cause display of a first user interface configured for navigation using one or more voice commands.

At step 708, output or display of the user interface may be caused. The computing device may send, to the playback device, an instruction to display the user interface determined based on the voice command and the received metadata. The playback device may be, for example, a set top box in communication with a television or other monitor capable of displaying a user interface. A user may then interact with and navigate the user interface using one or more voice commands.

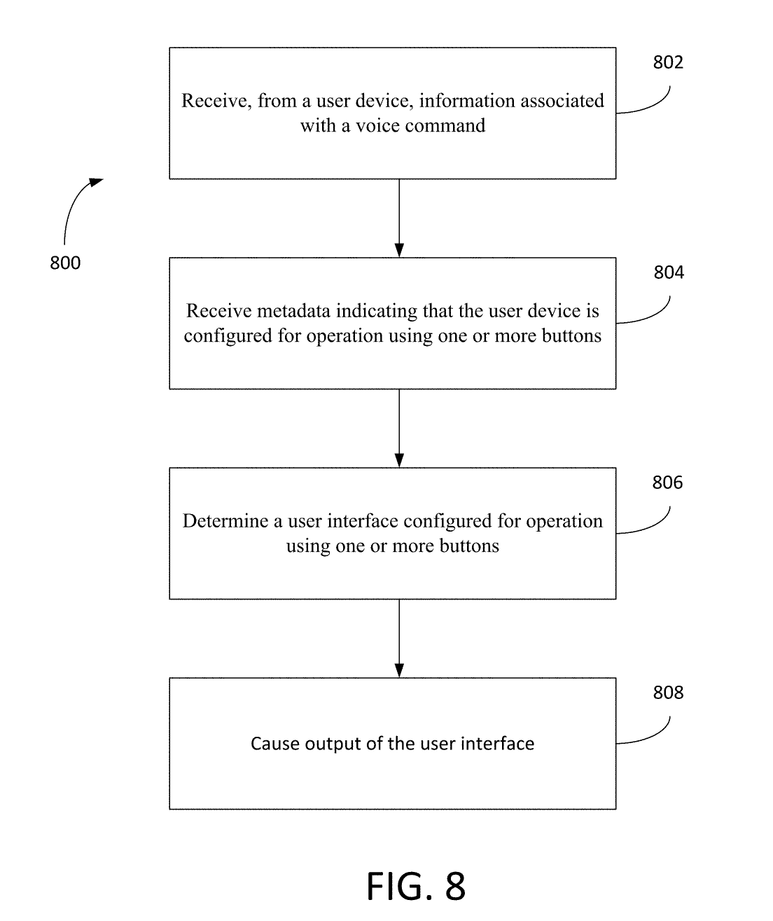

FIG. 8 illustrates an example method 800 in accordance with an aspect of the disclosure. At step 802, information associated with a voice command may be received from a first device, such as user device 102. The information may be received at a computing device, such as the computing device 110. The voice command may be a request for accessing a list of content offered by a service provider. For example, the voice command may comprise the command “show me popular horror movies.”

At step 804, metadata indicating that the user device is configured for operation using one or more buttons may be received. The metadata may comprise a device identifier, such as a PIN number, that identifies the user device to the computing device. The computing device, upon receiving an identifier from the user device, may determine that the user device is a voice-activated remote control configured to be operated using one or more buttons Additionally or alternatively, the metadata may comprise an indication of how the voice command and the metadata were transmitted by the user device. For example, a user device configured to be controlled using one or more buttons may send, to at least one of the computing device or the playback device, the audio file via a Radio Frequency (RF) signal.

At step 806, a user interface may be determined based on the voice command and the received metadata. One or more characteristics of the user interface may be configured based on the one or more operational characteristics associated with the user device. For example, upon receiving the voice command and the metadata indicating that the user device is configured for operation using one or more buttons, the computing device may cause display of a user interface configured for navigation using one or more buttons.

At step 808, output or display of the user interface may be caused. The computing device may send, to the playback device, an instruction to display the user interface determined based on the voice command and the received metadata. The playback device may be, for example, a set top box in communication with a television or other monitor capable of displaying a user interface. A user may then interact with and navigate the user interface using one or more buttons.

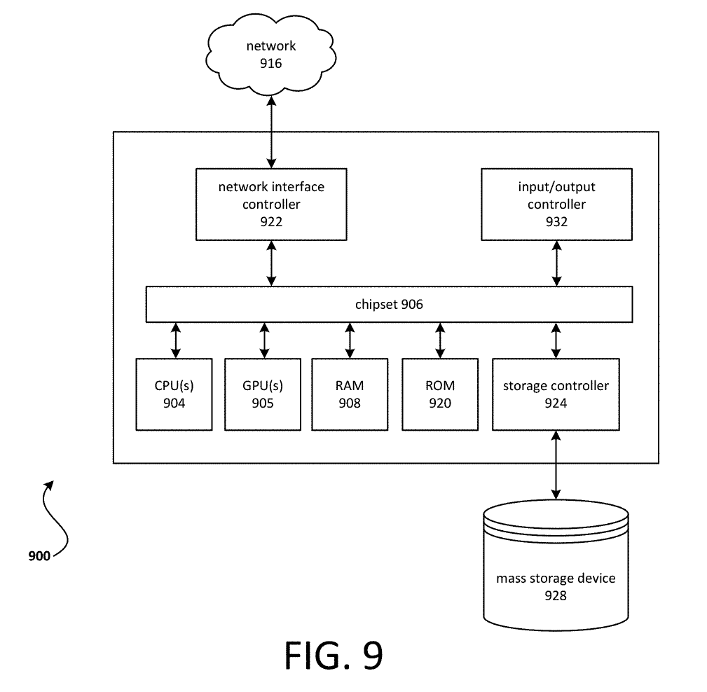

FIG. 9 depicts a computing device that may be used in various aspects, such as the servers, modules, and/or devices depicted in FIG. 1. With regard to the example architecture of FIG. 1, the user device 102, computing device 110, and/or the payback device 120 may each be implemented in an instance of a computing device 900 of FIG. 9. The computer architecture shown in FIG. 9 illustrates a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3 and 4.

The computing device 900 may include a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 708 used as the main memory in the computing device 900. The chipset 906 may provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems through local area network (LAN) 916. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 9, may store an operating system utilized to control the operation of the computing device 900. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 3 and 4.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving first information indicative of an audio input received at a user device;
receiving second information comprising metadata that identifies one or more operational characteristics associated with the user device;
determining, based on the first information and the second information, a user interface, wherein one or more characteristics of the user interface are configured based on the one or more operational characteristics associated with the user device; and
causing output of the user interface.

2. The method of claim 1, wherein determining a user interface comprises selecting the user interface from a plurality of user interfaces associated with one or more recognized user devices.

3. The method of claim 1,
further comprising determining, based on the second information, that the user device is a hands free device; and
wherein causing output of the user interface comprises causing output of a user interface capable of receiving input from the device using one or more voice commands.

4. The method of claim 1,
further comprising determining, based on the second information, that the user device is configured to receive commands using one or more buttons located on the user device; and
wherein causing output of the user interface comprises causing output of a user interface capable of receiving input from the user device using the one or more buttons.

5. The method of claim 1, wherein the metadata comprises a device identifier.

6. The method of claim 1, wherein the metadata comprises an indication of how the first information and the second information were transmitted by the user device.

7. The method of claim 1, wherein the audio input is a voice command for accessing a list of content offered by a service provider.

8. A method comprising
receiving first information indicative of an audio input received at a user device;
receiving second information comprising metadata that identifies one or more operational characteristics associated with the user device;
determining, based on the second information, whether the user device comprises a first type of operational characteristics or a second type of operational characteristics; and
in response to determining that the user device comprises a first type of operational characteristics, causing output of a first type of user interface; or
in response to determining that the user device comprises a second type of operational characteristics, causing output of a second type of user interface.

9. The method of claim 8, wherein the metadata comprises at least one of a device identifier or an indication of how the first information and the second information were transmitted by the user device.

10. The method of claim 9, wherein determining whether the user device comprises a first type of operational characteristics or a second type of operational characteristics comprises determining whether the second information was received over a Wi-Fi network or via a RF signal.

11. The method of claim 8, wherein the first type of device is a hands free device.

12. The method of claim 11, wherein the first type of user interface is capable of receiving input from the device using one or more voice commands.

13. The method of claim 8, wherein the second type of device is configured to receive commands using one or more buttons.

14. The method of claim 13, wherein the second type of user interface is capable of receiving input from the device using the one or more buttons.

15. A system comprising:
a processor; and
a non-transitory, computer-readable storage medium in operable communication with the processor, wherein the computer-readable storage medium contains one or more programming instructions that, when executed, cause the processor to:
receive first information indicative of an audio input received at a user device;
receive second information comprising metadata that identifies one or more operational characteristics associated with the user device;
determine, based on the first information and the second information, a user interface, wherein one or more characteristics of the user interface are configured based on the one or more operational characteristics associated with the user device; and
cause output of the user interface.

16. The system of claim 15, wherein determining a user interface comprises selecting the user interface from a plurality of user interfaces associated with one or more recognized user devices.

17. The system of claim 15, wherein the instructions, when executed, further cause the processor to determine, based on the second information, that the user device is a hands free device; and
wherein causing output of the user interface comprises causing output of a user interface capable of receiving input from the device using one or more voice commands.

18. The system of claim 15, wherein the instructions, when executed, further cause the processor to determine, based on the second information, that the user device is configured to receive commands using one or more buttons located on the user device; and
wherein causing output of the user interface comprises causing output of a user interface capable of receiving input from the user device using the one or more buttons.

19. The system of claim 15, wherein the metadata comprises a device identifier.

20. The system of claim 15, wherein the metadata comprises an indication of how the first information and the second information were transmitted by the user device.
